(19) United States
(12) Patent Application Publication
(10) Pub. No.: US 2026/0225295 A1
(43) Pub. Date: Aug. 6, 2026

(54) Glass Thickness Compensation System and Associated Method

(71) Applicant: Cooper-Standard Automotive Inc., Northville, MI (US)

(72) Inventors: Jason Ellul, Talbotville (CA); Long Au, Saint Lambert (CA); Olivier Helme, Ypsilanti, MI (US)

(73) Assignee: Cooper-Standard Automotive Inc., Northville, MI (US)

(21) Appl. No.: 19/156,867

(22) PCT Filed: Feb. 13, 2024
(86) PCT No.: PCT/US2024/015594

§ 371 Date: Aug. 14, 2025

Related U.S. Application Data
(60) Provisional application No. 63/445,746, filed on Feb. 15, 2023.

(51) Int. Cl. B29C 45/14; B29L 31/00

(52) U.S. Cl. CPC B29C 45/14065; B29C 45/14434; B29C 2045/14163; B29L 2031/778

(57) ABSTRACT

A system and associated process compensate for a variable thickness of an associated window on to which a seal is molded. The system includes a mold assembly dimensioned to receive an associated window therein. A first mold portion is mounted to move relative to a second mold portion so that a seal can be formed on the associated window. An insert is interposed between the first and second mold portions and is positioned to engage the associated window when the mold is closed. The compensation system includes a gas spring assembly operatively engaging the insert and is configured to accommodate variability in thickness of the associated window.

### CROSS-REFERENCE TO RELATED APPLICATION

This application claims priority from and benefit of the filing date of U.S. provisional application Ser. No. 63/445,746 filed Feb. 15, 2023, the entire disclosure of which is expressly incorporated herein by reference.

### BACKGROUND

This disclosure relates to an improved system for molding a seal material onto a window (also referred to as glass).

Currently, systems for molding a seal such as an elastomer onto a window (e.g., a vehicle window) incorporate a mechanical spring to provide limited adjustment between mold components. The mechanical spring accommodates some variation in thickness of the window associated with the mold.

Two primary problems result with the existing system. If the window thickness is too thin, the glass is improperly clamped in the encapsulation mold assembly and an undesired amount of flash results. On the other hand, if the window thickness is too thick, there is the potential that the window will break. In an attempt to address these different problems, the mechanical spring is intended to compensate for variance in the thickness of the window. Unfortunately, these problems still persist even when the mold incorporates a compensating mechanical spring. Further, any desired modification to the mechanical spring encounters extend, undesired downtime of the mold assembly.

Consequently, a need exists for an improved system and process that overcome these problems and others, and that can more easily accommodate variances in the window thickness, overcome possible excessive mold flash, and reduce the potential for window breakage in a manner that can be easily controlled and/or adjusted with minimal downtime for adjustment, as well as providing still other features and benefits.

### SUMMARY

The present application provides an improved system and method that of molding a seal on a window that compensates for variation in nominal thickness of the window.

A preferred embodiment of the system includes a mold assembly dimensioned to receive an associated window therein. A first mold portion is mounted to move relative to a second mold portion to close the mold assembly so that a seal can be formed on the associated window. An insert is interposed between the first and second mold portions positioned to engage with the associated window when the mold assembly is closed. A gas spring assembly operatively engages the insert and is configured to accommodate variability in thickness of the associated window.

The insert in a preferred arrangement supports the associated window thereon in the mold assembly.

The gas spring assembly may include a regulator for adjusting a gas pressure in the assembly.

The gas spring assembly may further include spaced apart, plural gas springs.

The gas spring assembly in one preferred arrangement includes a reservoir that stores a pressurized gas therein. At least one gas spring in the preferred arrangement is in selective communication with the reservoir to receive pressurized gas therefrom, and a controller between the reservoir and the at least one gas spring controls communication therebetween.

The controller in a preferred embodiment may include a regulator valve that selectively allows pressurized gas to flow from the reservoir to the at least one gas spring.

The controller of the preferred arrangement may include a bleed valve that selectively allows pressurized gas to vent from the system.

The bleed valve is preferably located between the regulator and the at least one gas spring.

The first and second mold portions in a preferred arrangement define a gap therebetween that is dimensioned for a preselected nominal thickness of the associated window.

The gas spring assembly may include plural gas springs in spaced location relative to one another and each gas spring operatively engages a preselected portion of the associated window.

The gas spring assembly may accommodate or compensate for the variability in the associated window thickness by at least one of (i) reducing seal flash and (ii) absorbing forces to limit potential breaking of the associated window.

A preferred method of compensating for a variable thickness of an associated window on to which a seal is molded includes providing a mold assembly dimensioned to receive an associated window therein, the mold assembly including a first mold portion mounted to move relative to a second mold portion to close the mold assembly so that a seal can be formed on the associated window.

The method may also include interposing an insert between the first and second mold portions positioned to engage the associated window when the mold assembly is closed.

The method further includes a gas spring assembly operatively engaging the insert and configuring the gas spring assembly to accommodate variability in thickness of the associated window.

The method of a preferred arrangement includes supporting the associated window on the insert in the mold assembly.

The method may further include providing a regulator as a part of the gas spring assembly and adjusting the gas pressure in the assembly with the regulator.

The method may further include providing spaced apart, plural gas springs in the gas spring assembly.

The method of a preferred arrangement further includes providing a reservoir, at least one gas spring, a controller in the gas spring assembly, storing a pressurized gas in the reservoir, selectively communicating pressurized gas from the reservoir to at least one of the gas springs, and using the controller to control communication between the reservoir and the at least one gas spring.

The method may include providing the controller with a regulator valve and selectively regulating pressurized gas to flow from the reservoir to the at least one gas spring.

The method may further include providing wherein the controller with a bleed valve and selectively bleeding pressurized gas from the system.

The method may further include locating the bleed valve between the regulator and the at least one gas spring.

The method may further include defining a gap between the first and second mold portions wherein the gap is dimensioned for a preselected nominal thickness of the associated window.

The method may further include positioning the plural gas springs of the gas spring assembly in spaced location relative to one another and operatively engaging each gas spring with a preselected portion of the associated window.

The method may further include accommodating the associated window thickness variability with the gas spring assembly by at least one of (i) reducing seal flash and (ii) absorbing forces to limit potential breaking of the associated window.

A primary benefit of the present disclosure relates to compensating for variability in the thickness of the window.

Another advantage is associated with automatically compensating for such variance.

Still another benefit is the reduced downtime associated with adjusting gas springs of the system to address variability in window thickness.

Yet another feature relates to eliminating window breakage, or alternatively reducing flash in response to variation from the nominal thickness of the window.

The ability to easily compensate for different conditions in the encapsulation mold while improving quality control and reducing the amount of scrap associated with window thicknesses that vary.

Benefits and advantages of the present disclosure will become more apparent from reading and understanding the following detailed description.

### BRIEF DESCRIPTION OF THE DRAWINGS

FIG. 1 Is a schematic illustration of the compensation system for a window encapsulation mold.

FIG. 2 schematically illustrates major components of the compensation system used in the window encapsulation mold assembly, and FIG. 3 is a similar schematic illustration (slightly enlarged) of the components of the compensation system.

FIG. 4 is a plan view of a preferred arrangement illustrating spaced placement of the compensation system.

FIG. 5 is an enlarged cross-sectional view taken generally along the lines 5-5 of FIG. 4.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include” or “may include” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A or/and B” used in the present disclosure include any and all combinations of words enumerated with them. For example, “A or B” or “at least one of A or/and B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise. Use of dimensions, temperatures, ranges, time, relationships (e.g., “perpendicular”, “parallel”), etc. that either use or do not use further adjectives such as “generally”, “substantially”, “about” or “approximately” in the description or claims are intended to cover both the specific dimension, temperature, range, time, relationship, etc., as well as a range of equivalents (function, way, or result) and only intended to be limited by teachings of the prior art.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

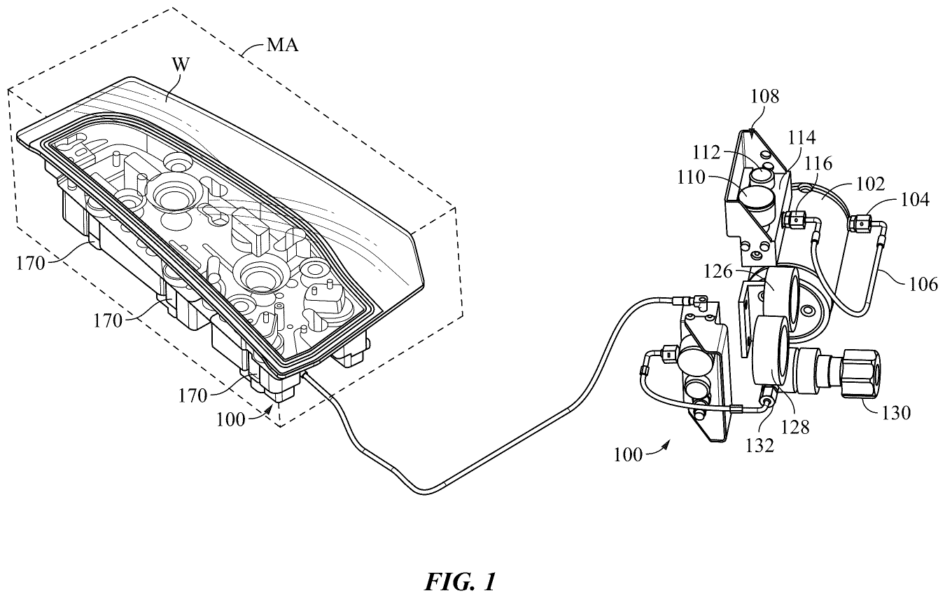

Turning first to FIG. 1, there is shown a compensation system 100 operatively incorporated into an encapsulation mold or mold assembly MA for a window W such as used to mold a seal on to, for example, automotive vehicle window (or sometimes referred to as glass) such as a fixed window, windshield, etc. The particular details of the mold assembly MA are generally known in the art, and may vary slightly from one application'to another, i.e., depending on dimensions of the window W, end uses of the window, specific seal materials, etc., so that further description of these mold assembly details are omitted here for purposes of focusing on the improved, particular compensation system 100 and associated method of the present disclosure.

The compensation system 100 includes a source (not shown) of pressurized fluid, such as a pressurized gas. The source is in selective communication with a pressurized supply tank or reservoir 102. The tank 102, for example, includes an inlet 104 that communicates with the source via a supply line or passage 106 extending from a control panel 108. The control panel 108 typically includes one or more components such as a display 110 and valve 112 associated with manifold 114 for selectively controlling and/or regulating the supply of pressurized gas to charge the tank 102. As illustrated, one end of supply line 106 communicates with the supply tank inlet 104 and an opposite end of the supply line is in fluid communication with a fluid connector 116 secured to the manifold 114 so that a sufficient supply of pressurized gas (e.g., nitrogen gas or N₂) is available to charge the tank 102 by actuating valve 112 (such as an on/off valve or bleed valve). The supply pressure can be monitored on the display 110.

In addition, the pressurized supply tank 102 includes an outlet 120 providing pressurized gas through connector 122 to a regulator assembly 124. The regulator assembly 124 may include at least one gauge, and preferably two gauges 126, 128, that display inlet pressure (gauge 126) and outlet pressure (gauge 128) supplied to and exiting from the regulator assembly, respectively. The regulator assembly 124 further includes an adjustable regulator valve 130 to selectively control outlet pressure from the regulator assembly to connector 132. In this manner, an associated mold press operator can monitor both the pressure level supplied from the upstream supply tank 102 (as displayed on gauge 126), and delivered downstream via fluid line or passage 134 (as displayed on gauge 128) to an inlet 136 of control panel 140.

In a manner similar to control panel 108, the control panel 140 preferably includes a manifold 142 and a display 144 and one or more valves 146 (e.g., on/off or bleed valves) that selectively controls and/or regulates gas pressure to outlet 148 of the control panel. One end of fluid line or passage 160 is secured in fluid communication with the outlet 148 of control panel 140, while an opposite end of the fluid line communicates with plural gas springs 170. Although six individual gas springs 170 are illustrated in spaced arrangement, and are arranged in one preferred embodiment to be in series to receive pressurized gas from line 160, one skilled in the art will appreciate that a greater or lesser number of gas springs may be provided. Likewise, the gas springs may be arranged in other ways (e.g., serial and/or parallel, closed loop versus open loop) to effectively and efficiently supply pressurized gas to the gas springs 170 situated in the mold assembly MA without departing from the scope and intent of the present disclosure.

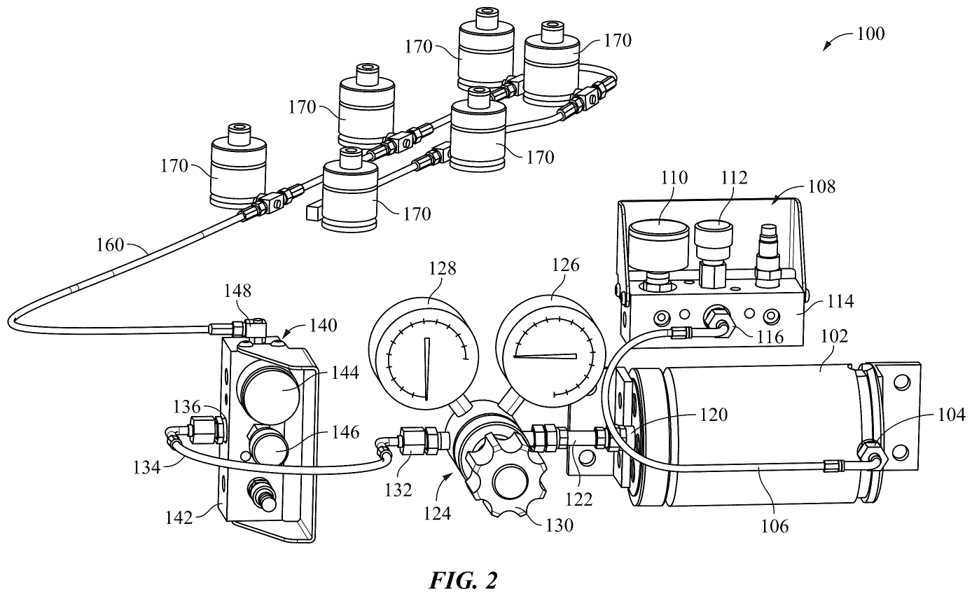

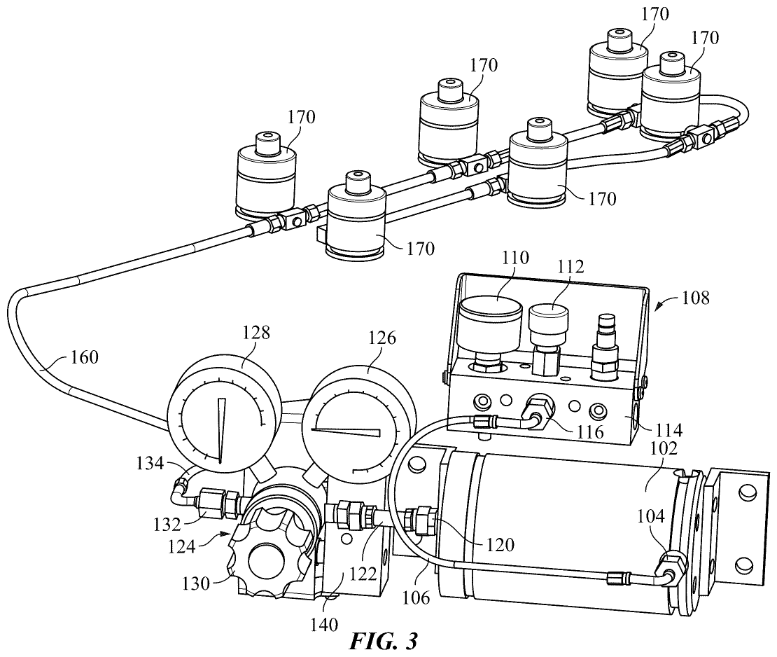

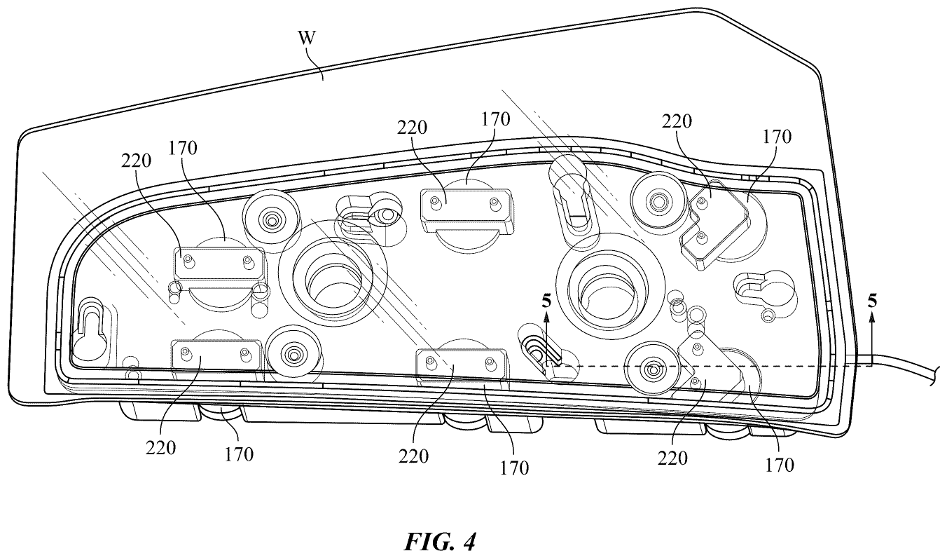

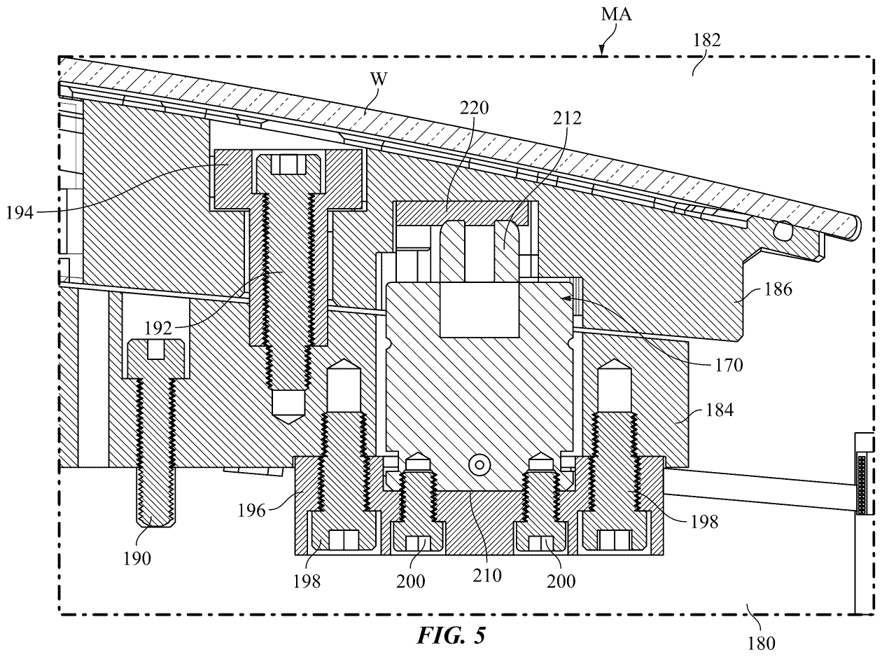

With continued reference to FIGS. 1-3 , and additional reference to FIGS. 4 and 5, additional detail of the positioning and function of the gas springs 170 will be described. Particularly, the gas springs 170 are preferably situated at spaced locations in the mold assembly MA. That is, generally the mold assembly MA includes a lower mold portion 180 and an upper mold portion 182. Further, a base 184 and adjusting insert 186 are received in the mold assembly MA. As perhaps best illustrated in FIG. 5, the base 184 is secured to the lower mold portion 180 via fastener(s) 190 (one of which is illustrated in FIG. 5), and the insert 186 is adjustably mounted via fastener(s) 192 and sleeve(s) 194 (only one set shown). A support plate 196 is mounted to the base 184 with fasteners 198 and similarly fasteners 200 secure a lower region of gas spring housing 210 to the support plate 196. A piston 212 of the gas spring 170 is selectively extended and retracted relative to the housing 210 in response to the pressure supplied to the gas springs and via line 160. A support member or wear plate 220 is provided for each gas spring and is abuttingly engaged by a terminal end of the movable piston 212 to transfer the piston force provided by the gas pressure to the gas spring housing to abuttingly engaging the support member. If desired, the support member 220 may be contoured (e.g., a cone-like surface) that allows the support member to conform to a contact surface area with the adjusting insert 186. The support members 220 may also be variably shaped to distribute the supporting forces from the associated gas springs 170.

If the thickness of the window W is less than nominal, the gas springs 170 will push the adjusting insert 186 and window W upwardly. This creates the desired seal necessary to avoid flash during the molding process. Alternatively, if the window W has a thickness greater than nominal, when the mold assembly MA closes, the upper mold 182 will push the window and adjusting insert 186 downwardly, and the gas springs 170 will equalize and absorb the additional pressure caused by the thicker window and thereby prevent breakage of the window. Consequently, it is recognized that the thickness of the window W may vary between a minimum and maximum tolerance. The present system 100 can compensate automatically for the variance in thickness of the window W. This reduces the potential that a thick window W breaks or reduces the amount of flash associated with a thin window W depending on the condition in the encapsulation mold assembly MA.

The reservoir tank 102 is charged with high-pressure gas, e.g., nitrogen, via control panel 108. Opening the regulator assembly 124 via the adjustable regulator 130 causes high pressure gas to flow into the gas springs 170. Supply pressure to the reservoir is shown on display 110 of control panel 108, and system pressure is shown on display 144 of control panel 140. By way of example only, spring pressure may be initially adjusted to approximately 50 bar/725 psi. If the system pressure is too high, bleed valve 146 on the second control panel 140 may be actuated (opened) to vent excess pressure. Alternatively, system pressure can be adjusted upwardly to a desired level, including upwardly to the total system pressure contained within the reservoir tank 102, using the regulator valve 130.

The system 100 provides a more stable, adjustable, controllable mold assembly and process. The gas pressure will equalize among the plural gas springs 170 to avoid flash and thereby provide proper clamping, as well as avoiding breaking of the window W. This system 100 provides a substantial improvement over prior uses of a mechanical spring that is set to a single force. The adjusting insert 186 supported by the gas springs 170 provides the benefits of minimizing downtime of the mold assembly MA and provide desired ease of adjustment when compared to a system provided with a mechanical spring. The present system can be easily adjusted by opening and closing the regulator valve 130. The present system advantageously avoids undesired flash, provides proper clamping, and reduces the potential for breaking the window W. An exemplary pressure of approximately 100 bar to approximately 300 bar may be suitable for pressure in reservoir tank 102. Input pressure to the gas springs out of the regulator 124 may be on the order of approximately 50-60 bar. Again, these pressure values are exemplary only and should not be deemed limiting.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

What is claimed is:

1. A system that compensates for a variable thickness of an associated window on to which a seal is molded, the system comprising:
a mold assembly is dimensioned to receive an associated window therein, a first mold portion mounted to move relative to a second mold portion to close the mold assembly so that a seal can be formed on the associated window;
an insert interposed between the first and second mold portions positioned to engage the associated window when the mold assembly is closed; and
a gas spring assembly operatively engaging the insert and configured to accommodate variability in thickness of the associated window.

2. The system of claim 1 wherein the insert supports the associated window thereon in the mold cavity.

3. The system of claim 1 wherein the gas spring assembly includes a regulator for adjusting a gas pressure in the assembly.

4. The system of claim 1 wherein the gas spring assembly includes spaced apart, plural gas springs.

5. The system of claim 1 wherein the gas spring assembly includes:
a reservoir that stores a pressurized gas therein;
at least one gas spring in selective communication with the reservoir to receive pressurized gas therefrom; and
a controller between the reservoir and the at least one gas spring that controls communication therebetween.

6. The system of claim 5 wherein the controller includes a regulator valve that selectively regulate pressurized gas flow from the reservoir to the at least one gas spring.

7. The system of claim 6 wherein the controller includes a bleed valve that selectively allows pressurized gas to vent from the system.

8. The system of claim 7 wherein the bleed valve is located between the regulator and the at least one gas spring.

9. The system of claim 1 wherein the first and second mold portions define a gap therebetween that is dimensioned for a preselected nominal thickness of the associated window.

10. The system of claim 9 wherein the gas spring assembly includes plural gas springs in spaced location relative to one another and each gas spring operatively engaging a preselected portion of the associated window.

11. The system of claim 1 wherein the gas spring assembly accommodates the associated window thickness variability by at least one of (i) reducing seal flash and (ii) absorbing forces to limit potential breaking of the associated window.

12. A method of compensating for a variable thickness of an associated window on to which a seal is molded, the method comprising:
providing a mold assembly dimensioned to receive an associated window therein, the mold including a first mold portion mounted to move relative to a second mold portion to close the mold assembly so that a seal can be formed on the associated window;
interposing an insert between the first and second mold portions positioned to engage the associated window when the mold assembly is closed; and
a gas spring assembly operatively engaging the insert and configured to accommodate variability in thickness of the associated window.

13. The method of claim 12 further comprising supporting the associated window on the insert in the mold assembly.

14. The method of claim 13 further comprising providing a regulator as a part of the gas spring assembly and adjusting the gas pressure in the assembly with the regulator.

15. The method of claim 12 further comprising providing spaced apart, plural gas springs in the gas spring assembly.

16. The method of claim 12 further comprising providing a reservoir, at least one gas spring, and controller in the gas spring assembly, and storing a pressurized gas in the reservoir;
selectively communicating pressurized gas from the reservoir to at least one of the gas springs; and
using the controller to control communication between the reservoir and the at least one gas spring.

17. The method of claim 16 further comprising providing the controller with a regulator valve and selectively regulating pressurized gas to flow from the reservoir to the at least one gas spring.

18. The method of claim 17 further comprising providing the controller with a bleed valve and selectively bleeding pressurized gas from the system.

19. The method of claim 18 further comprising locating the bleed valve between the regulator and the at least one gas spring.

20. The method of claim 12 further comprising defining a gap between the first and second mold portions wherein the gap is dimensioned for a preselected nominal thickness of the associated window.

21. The method of claim 20 further comprising positioning the plural gas springs of the gas spring assembly in spaced location relative to one another and operatively engaging each gas spring with a preselected portion of the associated window.

22. The method of claim 12 further comprising accommodating the associated window thickness variability with the gas spring assembly by at least one of (i) reducing seal flash and (ii) absorbing forces to limit potential breaking of the associated window.
